(19) United States
(12) Patent Application Publication
(10) Pub. No.: US 2015/0371316 A1
(43) Pub. Date: Dec. 24, 2015

(54) System and a Method for Automatically Detecting and Processing Physical Events Indicative of Status of an Order and Notifying Customers of the Same

(71) Applicant: Buzz Apps, Inc., Brooklyn, NY (US)

(72) Inventors: Robert Estelle, Portland, OR (US); Richard Liang, Brooklyn, NY (US)

(21) Appl. No.: 14/311,790

(22) Filed: Jun. 23, 2014

(51) Int. Cl. G06Q 30/06

(52) U.S. Cl. CPC G06Q 30/0635

(57) ABSTRACT

The present invention provides a system and a method for automatically detecting and processing physical events indicative of status of an order and notifying customers of the same. The method includes receiving an order from a client device. The order includes at least one item selected for purchase. The method also includes retrieving data including time for preparation of the item selected for the purchase and alerting of an existence of the order. The method also includes automatically detecting a physical event associated with the order. The physical event identifies commencement of the order. The method also includes automatically converting the physical event to a status of the order including an estimated time for completion of the order. The estimated time is calculated in view of the retrieved data and the physical event associated with the order. The method further includes transmitting the status of the order to the client device.

### CROSS-REFERENCES

This patent application claims the benefit of U.S. Provisional Application Ser. No. 61/842,334 filed Jul. 2, 2013, the contents of which are incorporated by reference herein.

### FIELD OF THE INVENTION

Embodiments of the invention are generally related to order notification techniques, and more specifically to a system and method for automatically detecting and processing physical events indicative of status of an order and notifying the customers of such status.

### BACKGROUND OF THE INVENTION

Many goods and service industries today provide customers with very little or no information on status of their orders until after fulfillment of the order such as by making a human announcement on a completed order. Thus, a customer either has to perform manual checking with a service person based on a given order number or confirmation code as to any progress made on the customer's order or has to constantly pay attention to a service person's manual announcement on completed orders.

Currently, some ordering systems utilize a manual notification scheme to notify the customers of their orders. For example, after an order is completed, an ordering fulfillment entity (for example, a service person) usually resorts to a pressing of a special button on a computer terminal to notify the customer of completion of the order. Such a customer notification scheme, however, requires staff training, adds an extra step to the operational sequence, and is laboring, ineffective, and often untimely. Under such a notification scheme, it is very common for the customer who has placed an order to wait a long time without receiving any notification on status of their order before the customer is presented with the completed order.

Today, some ordering system may utilize a combination of a manual and automatic notification to provide the customers with status of their orders. For example, when the order is placed, the service person may utilize a keyboard or a touch screen on a computing device to provide the customers of progress made on their orders. However, such notification scheme requires a human to manually monitor progress of the order and submit it on the computing device or to interrupt their normal work (preparing the order) to do so. Therefore, there is a need for an ordering system that automatically detects status on the customers' orders and notifies the customers of such status. There is also a need for an ordering system that can realize seamless, effective and timely notifications to customers as to the progress of their orders.

### SUMMARY OF THE INVENTION

Embodiments of the present invention provide a system and a method for automatically detecting and processing physical events indicative of status of an order and notifying the customers of such status.

In one embodiment, the method includes receiving an order from a client device such as a smartphone or web browser. The order includes at least one item selected for purchase. The method also includes retrieving data including estimated time for preparation of the item selected for the purchase and alerting a service person of the existence of the order. The method also includes automatically detecting a physical event associated with the order. The physical event identifies commencement of the order. The method also includes automatically converting the physical event to a status of the order including an estimated time for completion of the order. The estimated time for the completion of the order is calculated in view of the retrieved data and the physical event associated with the order. The method further includes transmitting the status of the order to the client device.

Embodiments of the present invention provide a system and a method for automatically processing the orders.

In one embodiment, the method includes receiving an order ticket associated with the order from an order processing system. The order ticket includes the at least one item selected for purchase. The method also includes printing the order ticket and detecting the printing of the order ticket. The method also includes generating a printed-ticket notification based on the detection of the printing of the order ticket and sending the printed-ticket notification to the order processing system. The method also includes detecting removal of the printed order ticket and generating a ticket-taken notification based on the detection of the removal of the order ticket. The method further includes sending the ticket-taken notification to the order processing system.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates an overview of a system 100 for automatically detecting and processing physical events indicative of status of an order and notifying customers of the same in accordance to an embodiment of the present invention.

FIG. 2 is a block diagram illustrating the components of the order processing system of FIG. 1 according to one or more embodiments of the present invention.

FIG. 3 illustrates a schematic block diagram illustrating details of components of the receiver device of FIG. 1 according to an embodiment of the present invention.

FIG. 3A is a block diagram illustrating the controller module of the receiver device of FIG. 3 according to an embodiment of the present invention.

FIG. 3B is a pictorial diagram illustrating functional modules of the receiver device of FIG. 3 according to an embodiment of the present invention.

FIG. 3C is a pictorial diagram illustrating functional modules of the receiver device of FIG. 3 according to an embodiment of the present invention.

FIG. 4 is a block diagram illustrating the client device of FIG. 1 according to an embodiment of the present invention.

FIG. 5 is a flow chart illustrating a method for automatically detecting and processing physical events indicative of status of an order and notifying customers of the same according to an embodiment of the present invention.

FIG. 6 is a flow chart illustrating a method for processing orders according to an embodiment of the present invention.

FIG. 7 illustrates a block diagram representation of a machine in the exemplary form of a computer system.

### DETAILED DESCRIPTION OF THE INVENTION

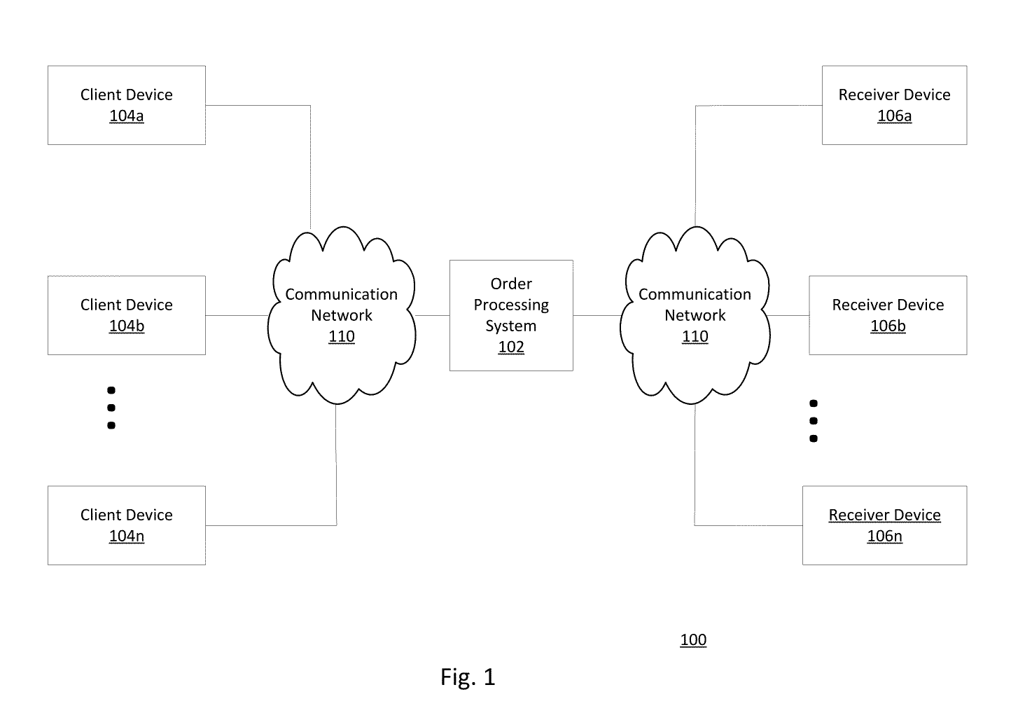

FIG. 1 illustrates an overview of a system 100 for automatically detecting and processing physical events indicative of status of an order and notifying customers of the same in accordance to an embodiment of the present invention. The physical event may include presence, removal, scanning or other detectable state of an order ticket, receipt or other printed medium with respect to a receiver device. The system 100 includes an order processing system 102, which serves as a neutral hub or network over which customers and entities can share and exchange information on the order. In some embodiments, the neutral hub or network is a cloud-computing network. In one embodiment, the order processing system 102 is a multi-tenant web scale service hosted in the cloud-computing network. In one embodiment, the order processing system 102 is a computer system, which may be a machine such as, for example, any variety of end user devices, such as a personal computer (PC), a laptop, a mobile phone, mobile smart phone, a tablet computer, handheld devices, netbooks, or any other computing device.

The order processing system 102 is communicatively coupled to a plurality of client devices 104 through a communication network 110, which may include Internet and/or one or more interconnected networks, such as one or more cellular networks, or one or more local area networks. The order processing system 102 is also communicatively coupled to a plurality of receiver devices 106 through the communication network 110. The order processing system 102 provides order processing functions, which may include but are not limited to, storing data, processing payments, receiving an order including at least one item for purchase from one or more client devices 104, associated with the order, determining a designated receiver device 106 among the plurality of receiver devices 106 based on the stored data, retrieving time from the stored data in view of the item selected for purchase in the order, alerting existence of the order by creating and dispatching one or more order tickets to the designated receiver device 106, detecting a physical event indicating progress of the order on the receiver device 106, processing the detected physical event to be converted to a status of the order including an estimated time for completion of the order and sending the status to the client device 104.

Each of the plurality of receivers devices 106 is adapted to detect an existence of the order including the order tickets from the order processing system 102, print the order tickets in an orderly and traceable manner, communicate with the order processing system 102 of the printed order ticket, notify service people of the existence of the ticket using visual or auditory alert means, allow for removal of the printed one or more ordered tickets and communicate with the order processing system 102 upon the removal of the printed order ticket. The receiver device 106 may detect the existence of the order by receiving an alert from the order processing system 102. The receiver device 106 may detect the existence of the order by periodically checking with the order processing system 102 for any new orders. In one embodiment, as shown in FIG. 1, the order processing system 102 and the receiver device 106 are two separate components, each of which functions independently. Although not shown, in another embodiment, the order processing system 102 and the receiver device 106 may be combined into a single component and function together.

Each of the plurality of the client devices 104 is used by a user to access a customer ordering interface, which may include user interfaces enabling the user to remotely submit an order to the order processing system 102. As such, in one embodiment, a user of the client device 104 is an individual. In another embodiment, a user of the client device 104 may be an entity, in which case the customer ordering interface may include an API (Application Programming Interface) to enable the entity to remotely submit an order to the order processing system.

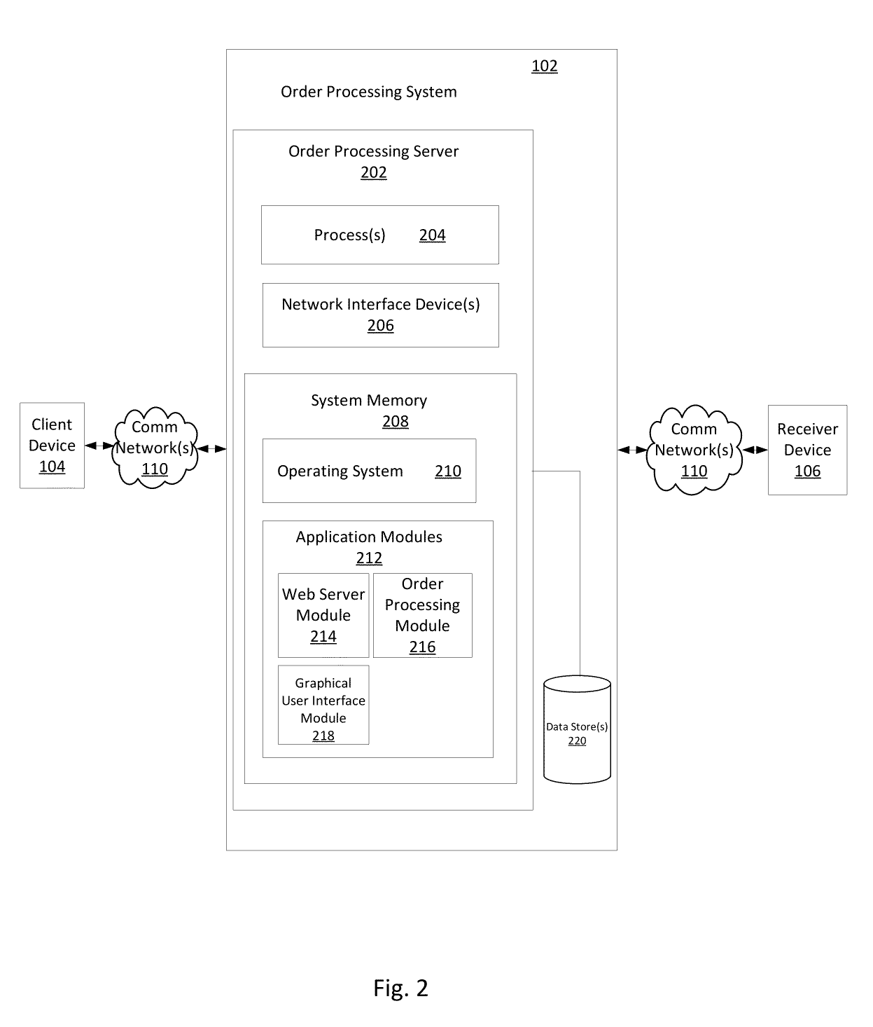

FIG. 2 is a block diagram illustrating the components of the order processing system 102 of FIG. 1 according to one or more embodiments of the present disclosure. In one embodiment, the order processing system 102 refers to an entity (such as an owner or an operator) owning and/or operating the physical order processing system. Referring to FIG. 2, the order processing system 102 comprises an order processing server (OPS) 202 and a data store (DS) 220 communicably coupled to the order processing server 202. In one embodiment, the OPS 202 refers to any of various types of computing devices, such as computer clusters, server pools, general-purpose personal computers, workstations, or laptops.

The DS 220 may be implemented in one or more of various forms, such as one or more relational or object databases, one or more local or distributed file systems, one or more removable storages, one or more memory caches, one or more memory clusters, or any combination thereof. Although, the DS 220 in FIG. 2 is illustrated to reside external to the OPS 202, one of ordinary skill in the art will appreciate that the DS 220 may reside in the OPS 202. In one embodiment, the DS 220 stores the data, which includes names of the multiple entities associated with receiver devices 106, items sold or provided by each of the multiple entities and time required for completion of each of the items. In one embodiment, the DS 220 stores information provided in the order by the client device 104. Such information includes, but not limited to, items in the order, name of the entity providing the items in the order, delivery or pick up location of the order, delivery or pick up time, name and contact information of a person placing the order, name and contact information of the person picking up the order, and payment of the order.

The OPS 202 may include a processor 204 (such as one or more microprocessor), a network interface device 206, and a system memory 208. In one embodiment, during operation of the OPS 202, an operating system (O/S) 210 and an application module 212 are loaded into the system memory 208. The OS 210 and the application module 212 when executed by the processor 204 are adapted to perform various functions based on their respective programmatic codes. The application module 212 may be implemented in various forms, such as executable programs, callable functions and routines, scripts that can be executed via running of one or more interpreter programs, services that may be invoked by standard or proprietary protocols, and programmatic objects containing both data and callable functions.

In one embodiment, application module 212 may include a web server module 214, an order processing module 216 and a graphical user interface (GUI) module 218. In one embodiment, the web server module 214 is configured to receive web requests of the orders from the client device 104 and later delivers a corresponding web response indicative of the to the client device 104. The web requests may be received from a client application (not shown) of the client device 104. In another embodiment, the web response may be delivered to the client application of the client device 104.

In one embodiment, the order processing module 216 is configured to receive orders from the client device 104, detect physical events indicative of status of the order and notify customers of the same via the client device 104. The order processing module 216 functions may include, but are not be limited to, assigning an order tracking code to identify the order, sending the order tracking code to the client device 104, processing electronic payment submitted by the customer for the order, setting an order status for the order. In one embodiment, the order processing module 216 retrieves data from DS 220 based on the order including the entity and the item(s) selected for purchase. As discussed above, the data includes multiple entities associated with multiple receiver devices 106, items sold by each of the multiple entities and time required for completion of each of the items.

In one embodiment, the order processing module 216 may also determine a designated receiver device among the multiple receiver devices 106 based on the entity, process the order to create an order ticket or an order message and route the order ticket to the designated receiver device by alerting the designated receiver device of an existence of the order. In one embodiment, the order ticket includes the information provided in the order. As discussed above, the information is stored in the DS 220, and includes, but not limited to, items in the order, name of the entity providing the items in the order, delivery or pick up location of the order, delivery or pick up time, name and contact information of a person placing the order, name and contact information of the person picking up the order, and payment of the order. In one embodiment, the order processing module 216 alerts the receiver device 106 of an existence of the order by dispatching the order ticket to the receiver device 106.

In one embodiment, the order processing module 216 automatically detects a first physical event associated with the order. The first physical event may include printing of the order at the designated receiver device 106. In one embodiment, the order processing module 216 receives a printed-ticket notification from the receiver device 106. The printed-ticket notification notifies that the order has been printed in the receiver device 106. The order processing module 216 may process the first physical event to interpret as a first status associated with the order. The first status may include receipt of the order by the entity fulfilling the order. The order processing module 216 may send the first status to the client device 104.

In one embodiment, the order processing module 216 automatically detects a second physical event associated with the order. The second physical event may include removal of the order from the designated receiver device 106. As such, the second physical event identifies commencement of the order by the entity fulfilling the order. In one embodiment, the order processing module 216 receives a ticket-taken notification from the receiver device 106. The ticket-taken notification notifies that a printed order ticket for the order (as identified by the assigned order tracking code) has been removed from the receiver device 106

In one embodiment, the order processing module 216 may process the second physical event by converting to a second status including an estimated time for completion of the order. In one embodiment, the estimated time for completion of the order is calculated based on the retrieved data and the second physical event. Such calculation includes determining a time of the second physical event and calculating how long it would take for the item(s) to be completed from the time of the second physical event based on the retrieved data. As discussed above, the retrieved data includes an estimated time for preparation of the item selected for the purchase. In one embodiment, the DS 220 stores the data, which includes the list of the items and an estimated time for preparation of each of the items in the list. In one embodiment, two or more items selected for purchase are different items. As such, the estimated time for preparation of each of the two items may be different amounts of times, which are added up to provide an estimated time for preparation of the two different items selected for purchase in the order. In one embodiment, two or more items selected for purchase are same items. As such, the estimated time for preparation of each of the two items is the same amount of time and the estimated time for preparation of the two same selected for purchase in the order would be remain that one same time. For example, item such as a mixed drink takes an estimated time of ten minutes for preparation and when the order includes two of the same mixed drinks, the total estimated time would still remain as ten minutes of time for preparation. The second status may also include a location to pick up the order. The order processing module 216 may send the second status to the client device 104. In another embodiment, the order processing module 216 may process the second physical event to interpret as another second status including commencement in preparation of fulfilling the order. In one embodiment, the order processing module 216 may send the another second status to the client device 104.

In one embodiment, the order processing system 102 detects a third physical event associated with the order. The third physical event may include the order is waiting to be printed at the designated receiver device 106. As such, the third physical event identifies that the order is waiting to be started by the entity fulfilling the order. In one embodiment, the order processing module 216 receives a ticket-wait notification from the receiver device 106. The ticket-wait notification notifies that the order has been waiting to be printed in the receiver device 106. The order processing module 216 may process the third physical event to interpret as a third status. The third status may include delay in commencing the order by the entity fulfilling the order. The order processing module 215 may send the third status to the client device 104.

In one embodiment, the order processing module 216 provides user interface (UI) instructions to the client device 104 to display information associated to the order. The GUI module 218 is configured to generate specific UI instructions, which may include both presentation semantics and data. Data included in the UI instructions (for viewing purpose) includes but not limited to menu/list of items, an order form, electronic cart information, information facilitating specifying of a delivery or a pickup location, and/or order-related notification information as provided by the order processing module 216. Typically, these UI instructions would be subsequently provided to the client application of the client device 104 by the order processing system 102 through, for example, the web server module 214 via one or more communication channels between the client device 104 (hosting the client application) and the order processing system 102, so that the client application presents user interfaces according to the received UI instructions. In one example, when the client application is a web browser, the GUI module 218 is configured to generate specific HTML pages (as UI instructions) intended for the client application to render one or more aforementioned order-related UI components. In another example, when the client application is a non-browser custom application, the GUI module 218 is configured to generate a data string including data to be displayed. Data included in the data string may be encoded or formatted according to a pre-defined protocol known to the client application, such that the client application, after receiving the data string, presents one or more suitable user interfaces to display the included data.

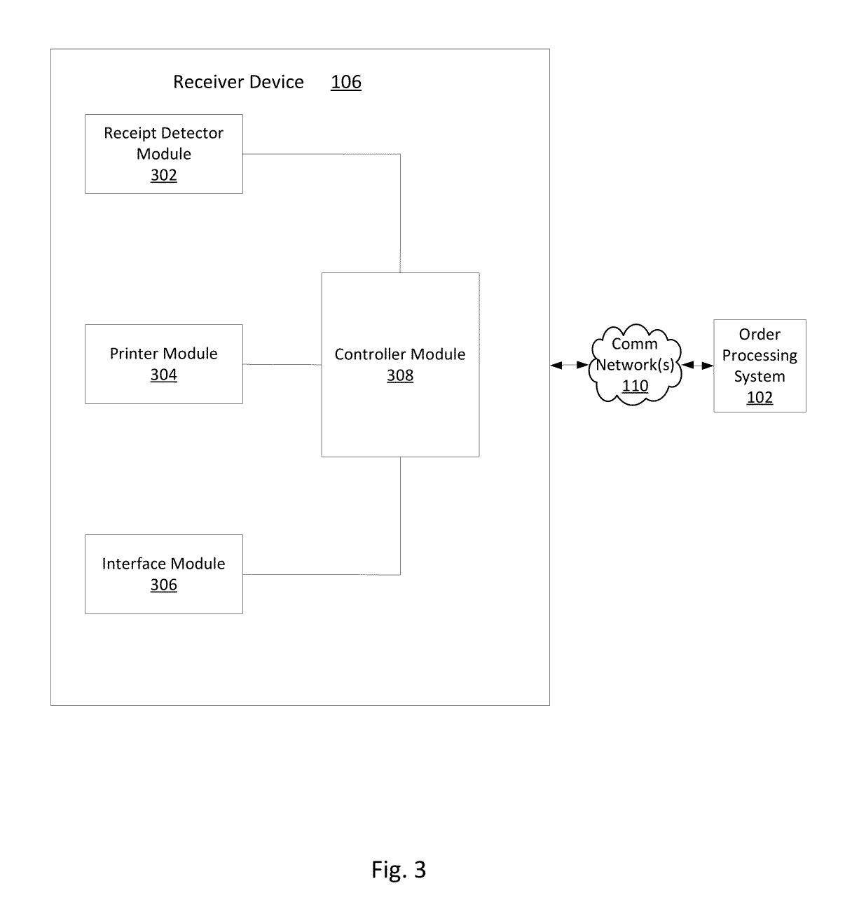

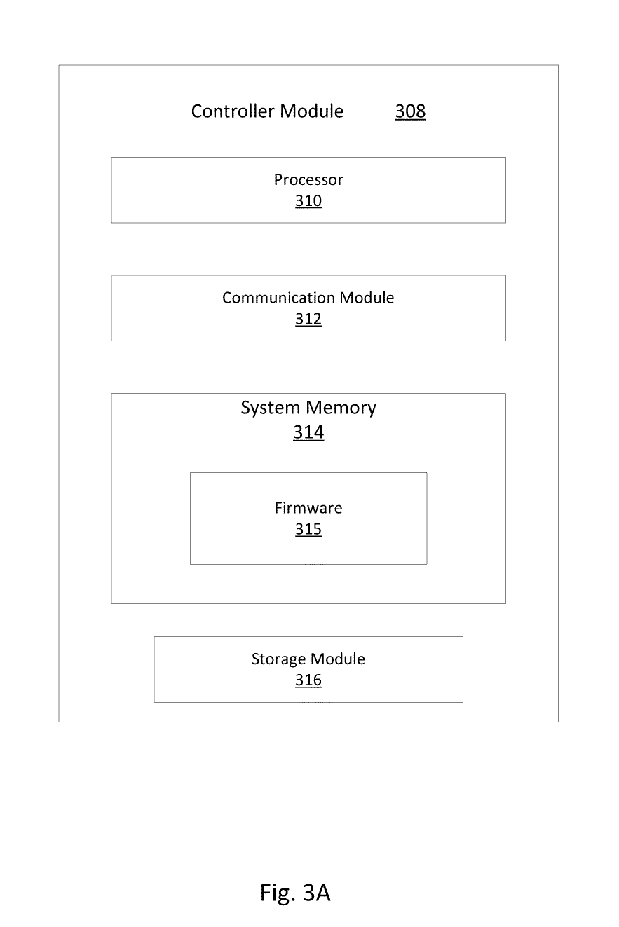

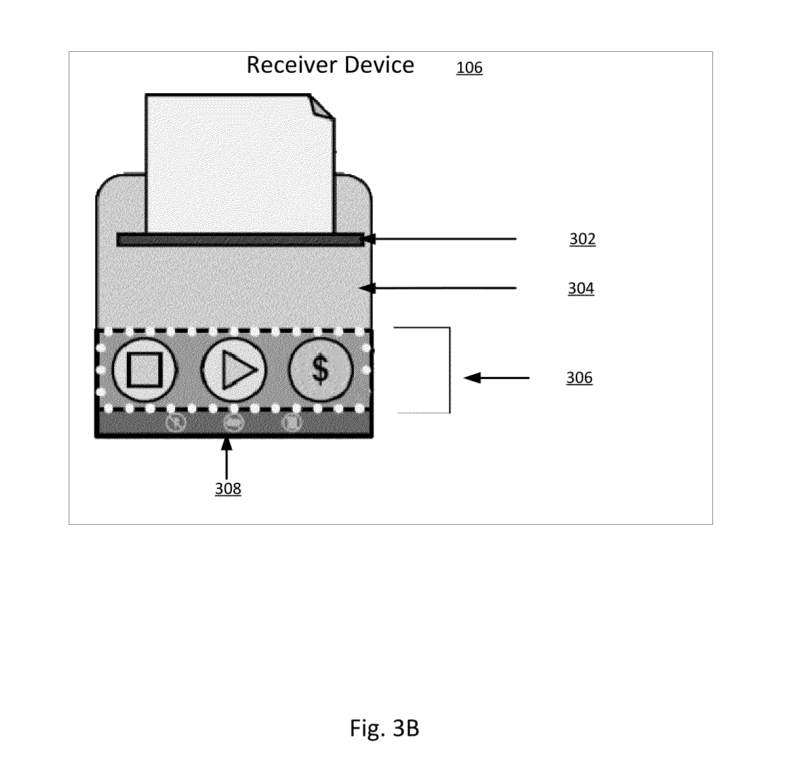

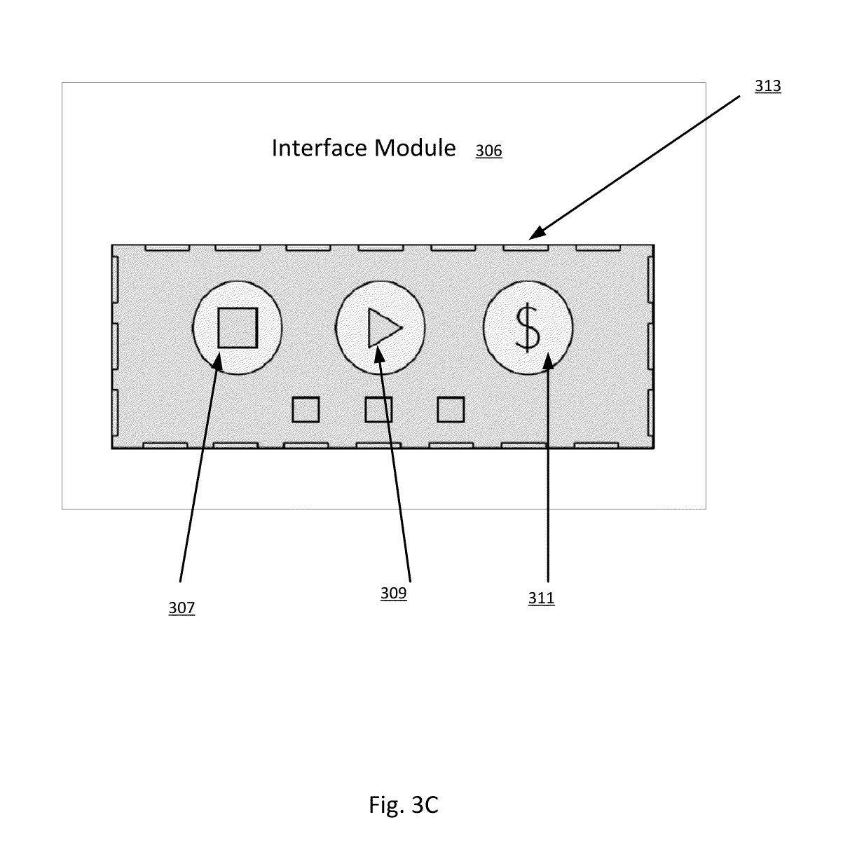

FIG. 3 illustrates a schematic block diagram illustrating details of components of the receiver device 106 of FIG. 1 according to an embodiment of the present invention. As shown, the receiver device 106 includes a receipt detector module 302, a printer module 304, an interface module 306 and a controller module 308. The controller module 308 is coupled to the printer module 304, the receipt detector module 302 and the interface module 306. In another embodiment, the controller module 308 functions to interface or communicate the actions in the receiver device 106 with external devices, such as the order processing 102 via either a dedicated line or one or more communication networks (such as the Internet, one or more local area networks, and/or one or more cellular networks) as described in greater detail below.

In one embodiment, the printer module 304 is a printer device, which functions to print out one or more order tickets. In this embodiment, the receipt detector module 302 detects actions associated with the printer device of the printer module 304. Such actions may include, but are not limited to, printing of the order ticket in the printer device, printed ticket is waiting in the printer device and removal of the ticket from the printer device. In one embodiment, the receipt detector module 302 informs the controller module 308 of the actions. In one embodiment, the interface module 306 functions to perform actions to control the printer device of the printer module 304. Such actions may include but are not limited to starting accepting orders, temporarily stopping accepting orders, and to print out an order summary.

FIG. 3A is a block diagram illustrating the controller module 308 of the receiver device 106 of FIG. 3 according to an embodiment of the present invention. As shown, the controller module 308 may comprise a processor 310, a communication module 312, a system memory 314 and a storage module 316. In one embodiment, the processor 310 includes software programs by software programs running in the one or more processors. The processor 310 may include a microprocessor or a microcontroller. In one embodiment, the communication module 312 of the controller module 308 functions to communicate with external devices such as the order processing system 102. The communication module 312 may wired and/or wireless networking capabilities with one more communication devices included therein, such as network interface device (NID), an RF unit, and antenna, or any combination thereof.

In one embodiment, the system memory 314 may comprise, inter alia, a firmware 315, which, when executed by the processor 310 may perform various functions that may be used to interface with, control or drive other component modules of the receiver device 106 such as the printer module 304, the receipt detector module 302 and the interface module 306. In another embodiment, the firmware 315 of the system memory 314, which, when executed by the processor 310 may perform various functions that may be used to interface with, control or drive, as well as interface or communicate with external devices such as the order processing system 102. Thus, the system memory 314 may include operating system and one or more receiver applications, which may work in concert with the order processing system 102 to enable the firmware 315 of the controller module 308 to perform various functions as described herein below.

In one embodiment, the firmware 315 of the controller module 308 receives the order tickets from the order processing system 102 via the communication module 312. The firmware 315, via a background process may constantly listen to, e.g. a communication channel established between the firmware 315 and the order processing system 102. The firmware 315 may send the order tickets to the printer module 304. In one embodiment, the firmware 315 may receive a first notification of printing of the order ticket in the printer module 304. The receipt detector module 302 may send the notification to the firmware 315 in the controller module 308. In one embodiment, the firmware 315 generates the printed-ticket notification indicating that the order ticket has been printed in the printer module 304 of the receiver device 106. The firmware 315 may send the printed-ticket notification to the order processing system 102 via the communication module 312. As discussed above, the order processing system 102 may detect the printed-ticket notification as the first physical event associated with the order. In one embodiment, the receiver device 106 includes an alert means such as a visual and/or audio means to notify the service person of the printed order ticket and to notify the service person of the order ticket waiting to be picked up from the receiver device, details of which are provided below with respect to FIGS. 3B and 3C.

In one embodiment, the firmware 315 of the controller module 308 receives a second notification of removal of the order ticket from the printer module 304. The receipt detector module 302 may send the second notification to the firmware 315 in the controller module 308. In one embodiment, the firmware 315 generates the ticket-taken notification indicating that the order ticket has been removed from the printer module 304 of the receiver device 106. In one embodiment, the ticket-taken notification provides a custom interpretation of preparation of fulfilling the order has commenced without specifying the underlying details of the ticket-taken notification. In another embodiment, the ticket-taken notification may notify both, namely, the underlying details of the ticket-taken notification and a custom interpretation of the notification. Such underlying details may include but are not limited to, a personal note to the customer of the client device 104 including the estimated time of the completion of the order. The firmware 315 may send the ticket-taken notification to the order processing system 102 via the communication module 312. As discussed above, the order processing system 102 may detect the ticket-taken notification as the second physical event associated with the order.

In other embodiments, the firmware 315 of the controller module 308 may receive a third notification that the order ticket is waiting in the printer module 304. The receipt detector module 302 may send the third notification to the firmware 315 in the controller module 308. In one embodiment, the firmware 315 generates the ticket-wait notification indicating that the order ticket is waiting to be printed at the printer module 304 of the receiver device 106. The firmware 315 may send the ticket-wait notification to the order processing system 102 via the communication module 312. As discussed above, the order processing system 102 may detect the ticket-wait notification as the third physical event associated with the order.

In one embodiment, the firmware 315 of the controller module 308 generates a ticket cancel notification when the firmware 315 does not receive a first notification of printing of the order ticket in the printer module 304. In another embodiment, the firmware 315 of the controller module 308 generates a cancel notification when the firmware 315 does not receive a second notification of removal of the order ticket from the printer module 304.

In one embodiment, the firmware 315 may send the ticket cancel notification to the order processing system 102 via the communication module 312. The ticket cancel notification may be processed by the order processing system 102 to indicate that the order has been canceled and any charges associated with the order are removed. The order processing system 102 may inform the client device 104 of the canceled order. The order processing system 102 may generate a canceled order ticket (indicating that the order has been canceled) and send the canceled order ticket to the firmware 315. The firmware 315 may send the canceled order ticket to the printer module 304 for printing at the receiver device 106 to notify the service person of the canceled order.

In some embodiments, the firmware 315 may control the printer module 304 through interfaces provided by the printer module in regard to regular printing functions, such as sending a new printing job, canceling an existing printing job, pausing active printing, and etc. Similarly, the firmware 315 may control the interface module 306 and the receipt detector module 302 through respective interfaces that these two modules provide.

The storage module 316 may include various internal and external storage media, such as RAM, ROM, hard disk, smart card, flash memory, and any external storage accessible via, e.g., the communication module 312 in the controller module 308 of the receiver device 106, such as a USB interface.

FIG. 3B is a pictorial diagram illustrating functional modules of the receiver device 106 of FIG. 3 according to an embodiment of the present invention. In one embodiment, the printer module 304 is a printer device and is configured to print the order tickets. In one embodiment, the receipt detector module 302 is a sensor device that detects whether a printed order ticket is waiting in the printer device or has been removed by a fulfillment personnel of the entity. The sensor device may be implemented using a so-called “ticket taken” sensor for receipt printers primarily used for carnival or gaming ticket printers. The sensor device may include a signaling or communication means (e.g., signaling or communication circuitries), which is used to signal or communicate with the controller module 308 regarding status of the tickets detected on the printer device. In one example, upon detecting that a printed ticket has been removed, the sensor may inform the controller module 308 about the ticket removal through the signaling or communication means. Also, shown is the interface module 306, which functions to perform actions to control the printer device of the printer module 304 as described in greater detail herein below.

FIG. 3C is a pictorial diagram depicting the interface module 306 of the receiver device 106 of FIGS. 3 and 3B according to an embodiment of the present invention. As shown in an exemplary embodiment, the interface module 306 is a front panel configured to have three control buttons having icons indicating “Pause”, 307 “Start” 309 and “Close Out”, 311 respectively. In one example, pressing the “Start” 309 buttons causes the printer module 304 to start or resume receiving one or more new orders and to print their corresponding order tickets. In another example, pressing the “Pause” 307 button causes the printer module 304 to pause or suspending receiving or printing any new order tickets. In a further example, pressing the “Close Out” 311 button causes the printer module 304 to stop receiving orders (e.g. for the night) and stop printing more order tickets and prints a total receipt.

In one embodiment, the interface module 306 may include alert means, such as visual alerts having one or more alert lights 313 shown in FIGS. 3B and 3C. The alert lights 313 may be configured to flash in different pre-defined patterns or manners each corresponding to a different situation that may need the attention of fulfillment personnel. As such, the alert lights 313 flashing in a specific pattern conveys to fulfillment personnel an occurrence of a corresponding situation, thereby prompting the fulfillment personnel to take one or more appropriate actions. For example, the one or more alert lights may flash in a first pattern when the interface module 306 is informed that a new ticket has been printed in the printer device of the printer module 304. The alert lights may flash in a second pattern (different from the first pattern) when the interface module 306 is informed that a printed ticket has been waiting too long without being removed from the printer device of the printer module 304. One of the ordinary skilled in the art would appreciate that various other alert means such as an audio alert may be used to achieve the same or similar alert functions.

In some embodiments, the firmware 315 of the controller module 308 may provide the alert means such as the alert lights 313 based on whether a new ticket is printed or whether a newly printed ticket has been waiting too long for removal. In one scenario, after the printer module 304 prints a new ticket, the printer module 304 may signal or communicate to the firmware 315 regarding same. The firmware may interface with the interface module so as to control or drive the alert means (such as alert lights 313 or an audio speaker (not shown)) to produce one or more visual and/or audio alerts which signal that a new ticket has been printed. For example, the alert lights 313 may flash in a particular pattern signaling that a new ticket has been printed. The audio speaker may produce a special audio pattern (e.g., a short beep) signaling the same.

In other embodiments, after learning that a new ticket is printed, the firmware 315 may instruct an internal timer of the controller module 308 to start running for the purpose of tracking time elapsed following the printing of the order ticket. When a pre-set threshold period of the time has elapsed (as, e.g., informed by the timer) and the firmware 315 does not receive any signaling or communication (e.g. from the receipt detector module) indicating that the newly printed ticket has been removed or torn out from the receipt detector module 302, the firmware 315 may interface with the interface module 306 so as to control or drive the alert means 313 (such as alert lights or an audio speaker (not shown)) to produce one or more visual and/or audio alerts which signal to the fulfillment personnel that a ticket has been waiting too long on the printer module 304. For example, the alert lights may flash in a particular pattern—which is notably visually different from the pattern signaling that a new ticket is printed—signaling that a ticket has been waiting too long without being removed. The audio speaker may produce a special sound (e.g., a long beep) signaling the same.

In further embodiments, the firmware 315 may control the control buttons of the printer module 304. In one embodiment, after the interface module 306 detects that any of the control buttons (such as the “Pause”, “Start” and “Close Out” buttons shown in FIGS. 3B and 3C) is pressed, the interface module 306 may signal or communicate to the firmware 315 regarding same. The firmware, 315 upon learning this state change, may interface with the printer module 304 as needed so as to achieve one or more functions intended by the pressing of the button. For example, the firmware 315 may respond to the pressing of the “Pause” button by suspending sending any new printing job for printing a received order (which may be buffered in the system memory 314 of the controller module 308 by the firmware 315) and/or controlling the printer module 304 so as to suspend printing any order tickets whose corresponding printing jobs are queued in the printer module 304. Similarly, the firmware 315 may respond to the pressing of the “Start” button by starting or resuming sending one or more new printing jobs for printing received orders (which may be buffered in the system memory 314 of the controller module 308) and/or controlling the printer module 304 so as to resume printing order tickets whose corresponding printing jobs are still queued in the printer module 304. Likewise, the firmware 315 may respond to the pressing of the “Close out” button by acquiring a total receipt (which may be done by either composing a total receipt or requesting a total receipt from an order processing server 202 of the order processing system 102) and sending the printer module 304 one final printing job of printing the total receipt that the printer module 304 will receive no more new printing jobs thereafter.

Although not shown, in one embodiment, the order processing system 102 may include the controller module 308 of the receiver device 106 in order to control remotely the functions of the printer module 304. As such, the order processing system 102 may control the print out of one or more order tickets in the printer module 304. In another embodiment, the order processing system 102 may include a receipt detector module 302 of the receiver device 106 in order to detect the actions of the printer module 304. As such, the order processing system may detect the printing of the order tickets printed tickets, waiting of the printed tickets in the printer and removal of the printed ticket. In a further embodiment, the order processing system may an interface module 306 of the receiver device 106 in order to control the actions of the printer module 304. As such, the order processing system 102 may start or resume printing of the order tickets, pause the printing of the order tickets, stop receiving more order tickets for printing and print out a total receipt.

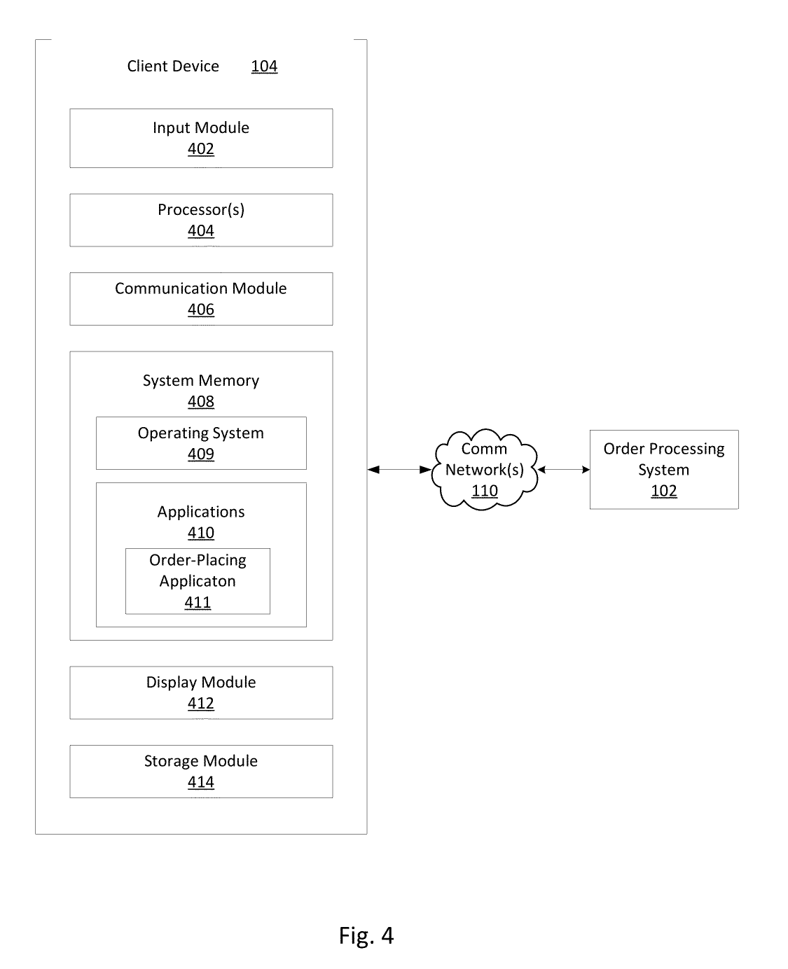

FIG. 4 is a block diagram illustrating the client device 104 of FIG. 1 according to an embodiment of the present invention. The client device 104 as shown in FIG. 4 may be any computing device having networking capabilities and loaded with one or more client software applications. Examples of a client device may include a smart phone, a PC, a notebook computer, a tablet and a PDA. The client device 104 may comprise, inter alia, an input module 402, one or more processors 404, a communication module 406, a system memory 408, applications 410, display module 412 and a storage module 414.

In one embodiment, the input module 402 receives input from a user (customer) and provides the received input to one or more processors 404 for further processing by software programs running in the one or more processors 404. The input module 402 may include but not limited to a keyboard, a mouse, input keys, a touch screen, a touchpad, or any combination thereof. Examples of the one or more processors 404 may include a microprocessor or a microcontroller. In one embodiment, the communication module 406 provides wired and/or wireless networking capabilities with one more communication devices included therein, such as network interface device (NID), an RF unit, and antenna, or any combination thereof.

In one embodiment, the system memory 408 may comprise, inter alia, an operations system 409 and one or more applications 410, which when executed by the processor 404 may work in concert with the order processing system 102 to perform various functions. One such function may include to enable the user to, inter alia, to submit one or more orders to the order processing system 102. Another function may include to receive one or more progress-indicating notifications from the order processing system 102. In one embodiment, the applications 410 include a web browser, which renders HTML pages received from the order processing system. In another embodiment, the applications 410 include one or more custom applications as an integral part of the ordering system. The one or more custom applications, in lieu of or in addition to a web browser, are specifically programmed to provide custom user interfaces (UIs) adapted to provide a customer ordering interface for the user. A custom application may exist in various forms. For example, a custom client application may be a standalone application running in a smart phone, a tablet, PC or notebook computer. A custom application may also be a software module running inside a specific application context, such as a so-called “Facebook app” running inside a Facebook context (a social networking context), or either a Java applet or an ActiveX control running inside a browser.

In one embodiment, the applications 410 are designed to provide a customer ordering interface that allows a user (customer) to interact with the order processing system 102 so as to enable the user to place an order and/or access order-related functions provided by the disclosed ordering system regardless, of whether the UIs are rendered by a web browser inside the HTML pages, or the custom UIs provided by a custom application (such as an order-placing application). Specifically, such UIs may include UI components enabling the user to browse a menu of items from partner venues, add items to the customer's electronic cart, specify a delivery or pickup location, submit an order for items selected into the cart, pay and tip with an electronic payment method, and view a received pickup notification. In one embodiment, specifying a delivery or pickup location can be for pickup at a specific section of the bar, or delivery to a table, section, area (inside and out) and to any legal place of delivery for the items. In another embodiment, a received pickup notification may contain a confirmation code corresponding with the order ticket already printed. For ease of discussion, hereinafter, “the application” refers to any of a web browser, one or more aforementioned custom applications, and any combination thereof, that is adapted to provide the aforementioned HTML-based UIs and/or custom UIs.

The display module 412 may include a display device, such as an LCD display screen, that is used to display user input data or output data provided by an application running in the client device. The display module 412 may include a touch screen, which allows user to input data. In such case, the display module 412 may also serve as an input device included in the input module 402. The storage module 414 may include various internal and external storage media, such as RAM, ROM, hard disk, smart card, flash memory, and any external storage accessible via, e.g., the communication module or an interface module (not shown) of the client device, such as a USB interface.

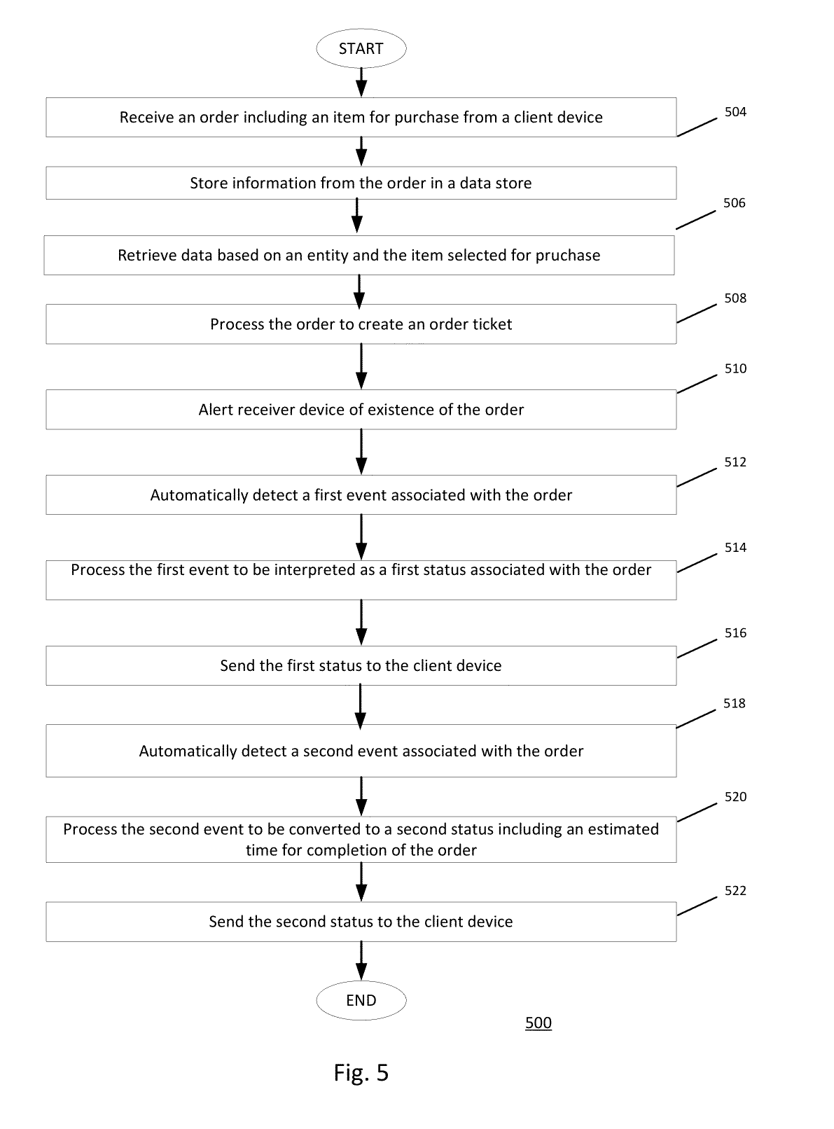

FIG. 5 is a flow diagram illustrating a method 500 for detecting and processing physical events indicative of status of an order and notifying customers of the same in accordance with an embodiment of the present invention. Method 500 may be performed by processing logic that may comprise hardware (e.g., circuitry, dedicated logic, programmable logic, microcode, etc.), software (such as instructions run on a processing device), firmware, or a combination thereof. In one embodiment, method 500 is performed by the order processing system 102 of FIGS. 1 and 2 executing in a computing device, such as the system 100 of FIG. 1.

Method 500 begins at block 502 where an order including an item selected for purchase is received from the client device 104. As discussed above, with client device 104, a customer may submit the order using a customer ordering interface provided by the client application on the customer's client device. Upon receiving the order, at block 504, information provided in the order is stored in the data store 320 of FIG. 3. As discussed above the information includes, but is not limited to, items in the order, name of the entity providing the items in the order, delivery or pick up location of the order, delivery or pick up time, name and contact information of a person placing the order, name and contact information of the person picking up the order, and payment of the order.

At block 506, data is retrieved based on the entity and the item(s) selected for purchase. As discussed above, the data includes multiple entities associated with corresponding receiver devices, items sold by each of the multiple entities and time required for completion of each of the items. At block 508, the order is processed to create an order ticket or an order message. In one embodiment, the order ticket includes the information provided in the order. At block 510, the receiver device corresponding to the entity is alerted of existence of the order by dispatching the order ticket to the receiver device. In one embodiment, the receiver device is same as the receiver device 106 as illustrated in FIG. 3. At block 512, a first physical event associated with the order is automatically detected. The first physical event may include printing of the order at the receiver device. In one embodiment, a printed-ticket notification notifying that the order has been printed is received from the receiver device. At block 514, the first event is processed to be interpreted as a first status associated with the order. The first status may include receipt of the order by an entity fulfilling the order. At block 516, the first status is sent to the client device 104.

At block 518, a second physical event associated with the order is automatically detected. The second physical event may include removal of the order ticket from the receiver device. In one embodiment, a ticket-taken notification notifying that a printed order ticket for the order (as identified by an assigned order tracking code or a confirmation code) has been removed from the receiver device is received from the receiver device. At block 520, the second physical event is processed to be converted to a second status including an estimated time for completion of the order. In one embodiment, the estimated time for completion of the order is calculated based on the retrieved data and the second physical event. Such calculation includes determining a time of the second physical event and calculating how long it would take for the item to be completed from the time of the second physical event based on the retrieved data including estimate time for preparation of the item. At block 522, the second status is sent to the client device. In one embodiment, the second status may also include a location to pick up the order.

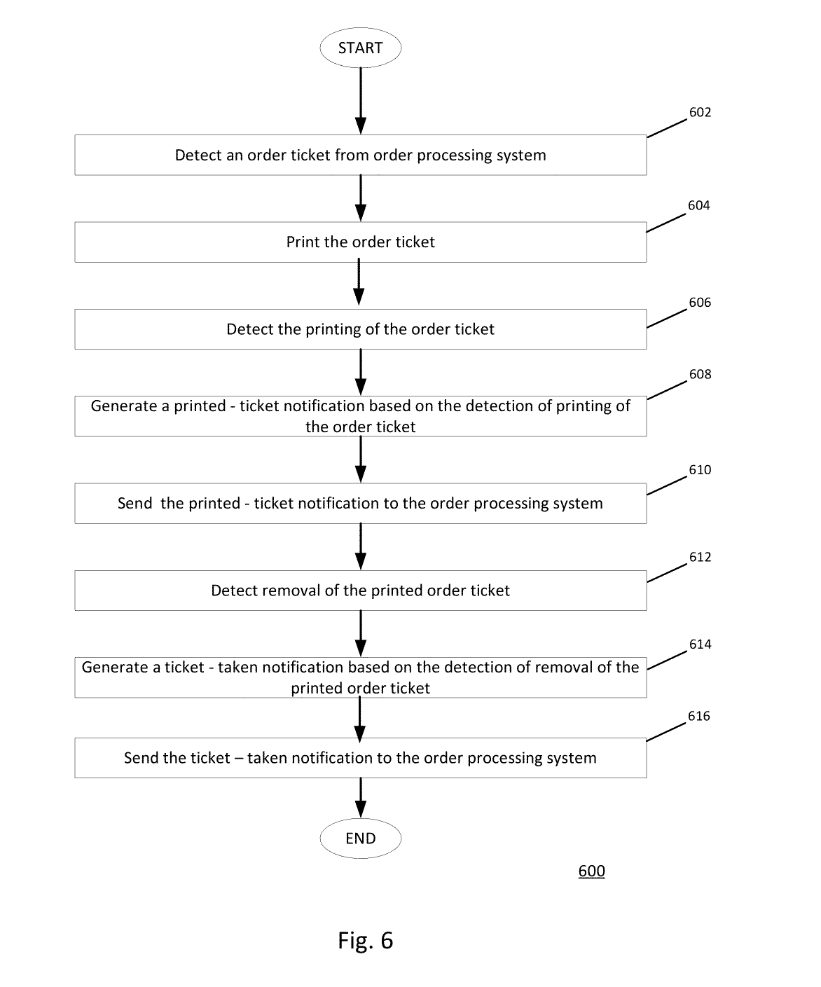

FIG. 6 is a flow diagram illustrating a method 600 for processing the orders in accordance with an embodiment of the present invention. Method 600 may be performed by processing logic that may comprise hardware (e.g., circuitry, dedicated logic, programmable logic, microcode, etc.), software (such as instructions run on a processing device), firmware, or a combination thereof. In one embodiment, method 600 is performed by the receiver device 106 of FIGS. 1 and 3 executing in a computing device, such as the system 100 of FIG. 1.

Method 600 begins at block 602 where an order ticket is detected from an order processing system. As discussed above, the existence of the order maybe detected by the receiving device 106 by receiving an alert from the order processing system 102. Also, the existence of the order maybe detected by the receiving device 106 by periodically checking with the order processing system 102 for any new orders. As discussed above the order ticket alerts of existence of the order. In one embodiment, the order processing system is same as the order processing system 102 as illustrated in FIG. 2. In one embodiment, the order ticket is received by the controller module 308 of the receiver device 106 as illustrated in FIG. 3. At block 604, the order ticket is printed. As discussed above, the order ticket is printed on the printer module 304 of the receiver device 106 as illustrated in FIG. 3. At block 606, the printing of the order ticket is detected. As discussed above, the receipt detector module 302 of the receiver device 106 as illustrated in FIG. 3 detects the printing of order ticket. At block 608, a printed-ticket notification is generated based on the detection of printing of the order ticket. As discussed above, the printed-ticket notification indicates that the order ticket has been printed. Also as discussed above, the printed-ticket notification is generated by the controller module 308 of the receiver device 106 as illustrated in FIG. 3. At block 610, the printed-ticket notification is sent to the order processing system.

At block 612, a removal of the printed order ticket is detected. As discussed above, the receipt detector module 302 of the receiver device 106 as illustrated in FIG. 3 detects the removal of the printed order ticket from the printer module 304. At block 614, a ticket-taken notification is generated based on the detection of removal of the printed order ticket. As discussed above, the ticket-taken notification is generated by the controller module 308 of the receiver device 106 as illustrated in FIG. 3. As discussed above, the ticket-taken notification notifies that the printed order ticket for the order has been removed. Also as discussed above, in one embodiment, the ticket-taken notification provides a custom interpretation of preparation of fulfilling the order has commenced without specifying the underlying details of the ticket-taken notification. Also, as discussed above, in another embodiment, the ticket-taken notification notifies, both, namely, the underlying details of the ticket-taken notification and a custom interpretation of the notification. At block 616, the ticket-taken notification is sent to the order processing system.

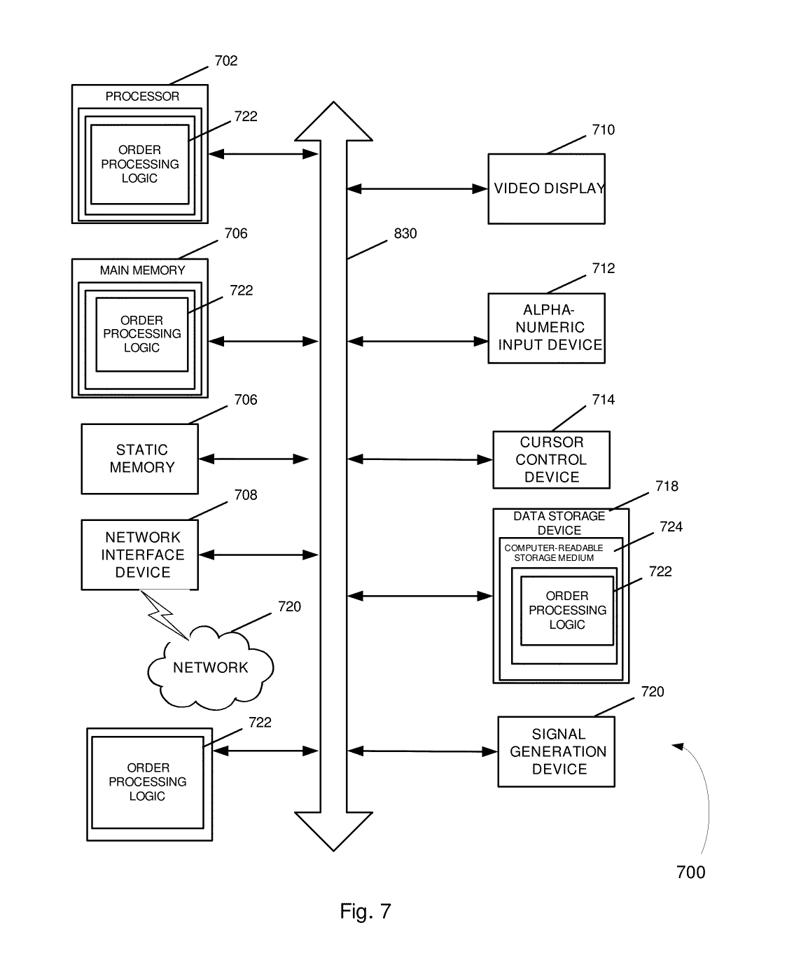

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 700 includes a processing device 702, a memory 706 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute order processing logic 722 for performing the operations and steps discussed herein. In one embodiment, order processing system 102 described with respect to FIGS. 1 and 2 perform the order processing logic 722.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-accessible storage medium (or more specifically a computer-readable storage medium) 720 on which is stored one or more sets of instructions (e.g. order processing logic 722) embodying any one or more of the methodologies of functions described herein, such as method 500 for detecting physical events indicative of status of the order and notifying the status as described with respect to FIG. 5. The order processing logic 722 may also reside, completely or at least partially, within the memory 704 and/or within the processing device 702 during execution thereof by the computer system 700; the memory 706 and the processing device 702 constituting machine-accessible storage media.

The machine-readable storage medium 720 may also be used to store the order processing logic 722 persistently containing methods that call the above applications. While the machine-accessible storage medium 720 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

The present invention provides several advantages. One such advantage includes a timely notification of the physical events associated with the order. In particular, the timely notification may allow a customer to make conscious time-saving and productivity-enhancing decisions. More specifically, it may take a busy order fulfillment entity (such as a busy restaurant or coffee-shop) a long time to get to an order (as indicated by fulfillment personnel removing the printed corresponding order ticket and commencing to prepare the order) which a customer placed using the customer's handheld-device (via the client application). With the availability of a notification indicating that the fulfillment personnel has commenced to prepare the placed order, customer may decide to stay home or office doing productive things before receiving such a notification, and leave home or office to pick up the ordered items only after receiving such a notification. This conscious decision allows the customer to avoid a scenario where the remote ordering customer leaves home or office too early, only to end up waiting a long time at the order fulfillment site before finally receiving the completed order, an unpleasant and time-wasting scenario, which is all-too-often and all-too-familiar under the conventional art.

Furthermore, the constant and reliable visibility into the status of a customer's order provided by the present invention affords customers a high degree of confidence in the ordering process. This confidence encourages ordering within a venue on their handheld device with the knowledge that their order will be processed in a more timely manner than traditional service. This enables the scenario in which a customer can place orders while at a busy bar, club, or restaurant without having to disengage their social activities to attempt to place orders at a crowded bar. Additionally, by paying for those orders in the application as they are placed, customers are also relieved of the inconvenience of closing out a tab or paying with cash or credit card.

Furthermore, by eliminating the transactional overhead of traditional service or forcing service staff to interact with complex computer- or tablet-based systems, the present invention provides an enhanced operational efficiency for service staff.

Another advantage includes that the customer can specify a delivery or pickup location when placing the order using the customer ordering interface provided by the client application. This is a feature advantageous and desirable to both order fulfillment personnel and the remote ordering customer. Specifically, in one embodiment, information about the specified delivery or pickup location is automatically included in the order information and is subsequently included in a corresponding order ticket printed out by the printer module of the receiver device. Fulfillment personnel, such as a waiter or a bartender, may then learn of the location information from the order ticket and directly deliver the completed order to the specified delivery or pickup location, thereby obviating the fulfillment personnel from any burden to look for the ordering customer and achieving an increase in work efficiency of the fulfillment personnel. On the other hand, the remote ordering customer, knowing with full confidence that the completed order (ordered items) will be served or provided in the specified location, may directly head to the specified delivery or pickup location to receive the completed order, thereby obviating any need for the ordering customer to inquire the fulfillment personnel from time to time about whether the placed order has been completed or not.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A method comprising:
(a) receiving, by a processing device, an order from a client device, wherein the order comprises an item selected for purchase;
(b) retrieving, by the processing device, data comprising time for preparation of the item selected for the purchase;
(c) alerting of an existence of the order;
(d) automatically detecting a physical event associated with the order, wherein the physical event identifies commencement of the order;
(e) automatically converting, by the processing device, the physical event to a status of the order comprising an estimated time for completion of the order, wherein the estimated time is calculated in view of the retrieved data and the physical event associated with the order; and
(f) transmitting, by the processing device, the status of the order to the client device.

2. The method of claim 1 further comprising automatically sending a location for one of a delivery or pick up of the order to the client device.

3. The method of claim 1 wherein the order comprises the entity associated with the item selected for the purchase and a location for one of a delivery or pick up of the order.

4. The method of claim 3 further comprising processing the order to create an order ticket.

5. The method of claim 4 wherein the alerting comprising dispatching the order ticket to a receiver device corresponding to the entity associated with the item selected for the purchase, wherein the order ticket is printed at the receiver device.

6. The method of claim 5 wherein the physical event comprises removal of the printed order ticket from the receiver device.

7. The method of claim 6 further comprising determining a second time of the physical event, wherein the estimated time for completion of the order is calculated based on the second time of the physical event and the time for the preparation of the item selected for purchase.

8. The method of claim 5 further comprising automatically detecting a first physical event associated with the order, wherein the first physical event identifies receipt of the order by the receiver device, wherein the first physical event is detected when the order ticket is printed at the receiver device.

9. A system, comprising:
a memory;
a processing device communicably coupled to the memory to:
(a) receive an order from a client device, wherein the order comprises an item selected for purchase;
(b) retrieve data comprising time for preparation of the item selected for the purchase;
(c) alert existence of the order;
(d) automatically detect a physical event associated with the order, wherein the physical event identifies commencement of the order;
(e) automatically convert the physical event to a status of the order comprising an estimated time for completion of the order, wherein the estimated time is calculated in view of the retrieved data and the physical event associated with the order; and
(f) transmit the status of the order to the client device.

10. The system of claim 9, wherein the processor to automatically send a location for one of a delivery or pick up of the order to the client device.

11. The system of claim 9 wherein the processing device processes the order to create an order ticket.

12. The system of claim 11 wherein the alert comprises dispatch the order ticket to a receiver device corresponding to the entity associated with the item selected for purchase, wherein the order ticket is printed at the receiver device.

13. The system of 12 wherein the processing device to determine a second time of the physical event, wherein the estimated time is calculated based on the second time of the physical event and the time for the completion of the item selected for purchase, wherein the physical event comprises removal of the printed order ticket from the receiver device.

14. The system of claim 12 wherein the processing device to automatically detect a first physical event associated with the order, wherein the first physical event identifies receipt of the order by the receiver device, wherein the first physical event is detected when the order ticket is printed at the receiver device.

15. A non-transitory machine-readable storage medium including data that, when accessed by a processing device, causes the processing device to perform operations comprising:
(a) receiving, by a processing device, an order from a client device, wherein the order comprises an item selected for purchase;
(b) retrieving, by the processing device, data comprising time for preparation of the item selected for the purchase;
(c) alerting of an existence of the order;
(d) automatically detecting a physical event associated with the order, wherein the physical event identifies commencement of the order;
(e) automatically converting, by the processing device, the physical event to a status of the order comprising an estimated time for completion of the order, wherein the estimated time is calculated in view of the retrieved data and the physical event associated with the order; and
(f) transmitting, by the processing device, the status of the order to the client device.

16. The non-transitory machine-readable storage medium of claim 15, wherein the operations further comprising automatically sending a location for one of a delivery or pick up of the order to the client device.

17. The non-transitory machine-readable storage medium of claim 15, wherein the operations further comprising processing the order to create an order ticket.

18. The non-transitory machine-readable storage medium of claim 17 wherein the alerting comprising dispatching the order ticket to a receiver device corresponding to the entity associated with the item selected for the purchase, wherein the order ticket is printed at the receiver device.

19. The non-transitory machine-readable storage medium of claim 18, the operations further comprising determining a second time of the physical event, wherein the estimated time is calculated based on the second time of the physical event and the time for the preparation of the item selected for purchase, wherein the physical event comprises removal of the printed order ticket from the receiver device.

20. The non-transitory machine-readable storage medium of claim 18, the operations further comprising automatically detecting a first physical event associated with the order, wherein the first physical event identifies receipt of the order by the receiver device, wherein the first physical event is detected when the order ticket is printed at the receiver device.
